(19) United States
(12) Patent Application Publication
(10) Pub. No.: US 2008/0037145 A1
(43) Pub. Date: Feb. 14, 2008

(54) Rear view system and adjusting method thereof

(76) Inventor: Fu-Jeng Chen, Yungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/497,393

(22) Filed: Aug. 2, 2006

(51) Int. Cl. G02B 5/08

(52) U.S. Cl. 359/841

(57) ABSTRACT

A rear view system for a transportation device includes a rear view means, a sensor and a controller. The sensor is used for generating a movement signal according to the movement of the transportation device. The controller is used for controlling the rotation of the rear view means according to the movement signal. Moreover, a method for adjusting the visual angle of a rear view means equipped in a transportation device is also disclosed.

### BACKGROUND

1. Field of Invention

The present invention relates to a rear view system. More particularly, the present invention relates to a rear view system that can automatically adjust the field of rear vision for a driver of a transportation device.

2. Description of Related Art

In the past century, the transportation industry has made great progress, especially in the automobile industry. As production techniques and materials improve, vehicles are becoming much better. The prosperity of the vehicle industry also induces advances in related fields. However, high-end sedans and sports utility vehicles or ordinary cars always emphasize on the same two issues, i.e., safety and comfort. Therefore, vehicle industry does not only rely on its own techniques for vehicle development, but also on progress in related fields.

Vehicle safety is the most important consideration for vehicle designers, vehicle manufacturers, and drivers. In a moving vehicle, the driver often has to use the rear view mirror to check the back in addition to watching the front through the windshield. Thus, the rear view mirror plays an important role in driving safety.

Reference is made to FIG. 1A and FIG. 1B. FIG. 1A is a diagram showing the field of rear vision for a conventional rear view mirror when the vehicle goes straight. FIG. 1B is a diagram showing the field of rear vision for a conventional rear view mirror when the vehicle makes a right turn. Both exterior and interior conventional rear view mirrors are at a fixed visual angle when the vehicle is driven. Drivers often adjust the visual angle of the rear view mirrors to maximize the rear view mirror field of rear vision when driving straight. As shown in FIG. 1A, when the vehicle goes straight, both the interior rear view mirror 120 and exterior rear view mirror 110 have good fields of rear vision. But as shown in FIG. 1B, when the vehicle makes a right turn, the visual angle of the exterior mirror 110 and the interior mirror 120 is still fixed, so the field of rear vision the driver can obtain in the right rear direction deteriorates. Thus, although the driver takes great care when turning right or turning left, accidents still occur at crossroads and other places where vehicles may turn.

### SUMMARY

It is therefore an aspect of the present invention to provide a rear view system for a transportation device which can automatically adjust the visual angle of a rear view means according to the movement of the transportation device.

In accordance with the foregoing and other aspects of the present invention, a rear view system for a transportation device including a rear view means, a sensor and a controller is provided. The sensor is used to generate a movement signal according to the movement of the transportation device. The controller is used to control the rotation of the rear view means according to the movement signal. The transportation device may be a vehicle, a motorcycle or a ship. Furthermore, the rear view means may be a rear view mirror. The following embodiment will assume the transportation device is a vehicle for easy to illustrate.

The sensor may be a differential. Because many commercial vehicles originally have a differential equipped therein, the rear view system may employ this differential as the sensor. Thus, no additional sensor needs to be added to the vehicle.

The sensor may also be a gyroscope device. Because different vehicles have different differentials, the controller may have to be adapted to identify the movement signal generated form different differentials. In order to avoid adapting the controller, the rear view system may employ the gyroscope device as the sensor. Thus, the rear view system will have the ability to be compatible with different vehicles without adapting the controller.

The rear view system may further include a transmitter. The transmitter is electrically connected to the controller for transmitting the movement signal to a global positioning system (GPS). Using the movement signal and a map originally installed in the GPS, the GPS will have the ability to show the position of the vehicle even if the vehicle is driven into a place without radio signals from satellites (such as a basement or a tunnel).

According to one embodiment of the present invention, the rear view means is an exterior mirror, and the exterior mirror has a driving means (such as a motor) configured therein for rotating the exterior mirror. The controller is electrically connected to the driving means for controlling the driving means. That is, the controller generates a control signal response to the movement signal. Then, the driving means rotates the exterior mirror according to the control signal.

The rear view system may further include a cell phone repeater, a digital video broadcasting (DVB) antenna and/or a radio antenna electrically connected to the controller. Thus, cell phones, digital televisions (DTV) and/or radios would have excellent signal reception in the vehicle, which has the rear view system equipped therein according to this embodiment, because the controller is electrically connected to the driving means configured in the exterior mirror (that is, the circuit of the controller is extended to the outside).

According to another embodiment of the invention, the rear view means is an interior mirror, and the rear view system further includes a driving means (such as a motor) coupled with the interior mirror for rotating the interior mirror. The controller is electrically connected to the driving means to control the driving means. That is, the controller generates a control signal response to the movement signal. Then, the driving means rotates the interior mirror according to the control signal.

It is another aspect of the present invention to provide a method for adjusting the visual angle of a rear view means equipped in a transportation device. The method rotates the rear view means according to the movement of the transportation device, so that a driver of the transportation device can obtain a better field of rear vision to avoid accidents.

In accordance with the foregoing and other aspects of the present invention, a method for adjusting the visual angle of the rear view means equipped in a transportation device is provided. First, the movement of the transportation device is sensed. Then, the rear view means is rotated according to the movement of the transportation device. The sensing step may be performed by a differential or a gyroscope device. Similarly, the following embodiment will assume the transportation device is a vehicle for easy to illustrate.

More specifically, when the vehicle makes a right turn, the rear view means is rotated counterclockwise (looking from the top of the vehicle) to give the driver of the vehicle a better field of right-side rear vision. Similarly, when the vehicle makes a left turn, the rear view means is rotated on clockwise (looking from the top of the vehicle) to give the driver of the vehicle a better field of left-side rear vision. The rear view means may be an exterior mirror, interior mirror or both.

In conclusion, the rear view system according to the present invention can automatically adjust the visual angle of the rear view means according to the movement of the transportation device. Thus, the driver can obtain a better field of rear vision, so that the driver can drive more safely.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a diagram showing the field of rear vision for a conventional rear view mirror when the vehicle goes straight;

FIG. 1B is a diagram showing the field of rear vision for a conventional rear view mirror when the vehicle makes a right turn;

FIG. 2A is a block diagram of a rear view system according to one preferred embodiment of this invention;

FIG. 2B is a block diagram of a rear view system according to another preferred embodiment of this invention;

FIG. 2C is a block diagram of a rear view system according to still another preferred embodiment of this invention;

FIG. 3 is a flow chart illustrating a method for adjusting the visual angle of a rear view means equipped in a transportation device according to one preferred embodiment of the present invention; and

FIG. 4 is a diagram showing the field of rear vision in the rear view means according to one preferred embodiment of the present invention when the vehicle turns right.

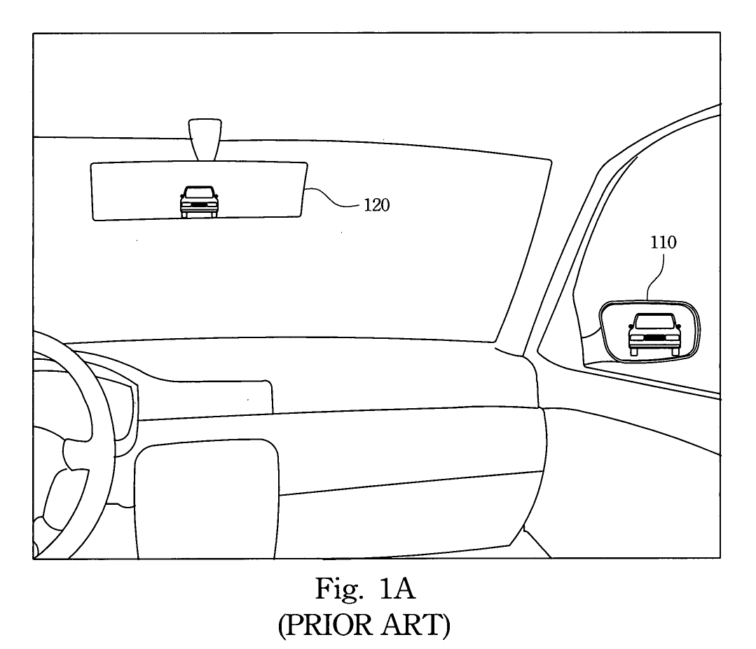

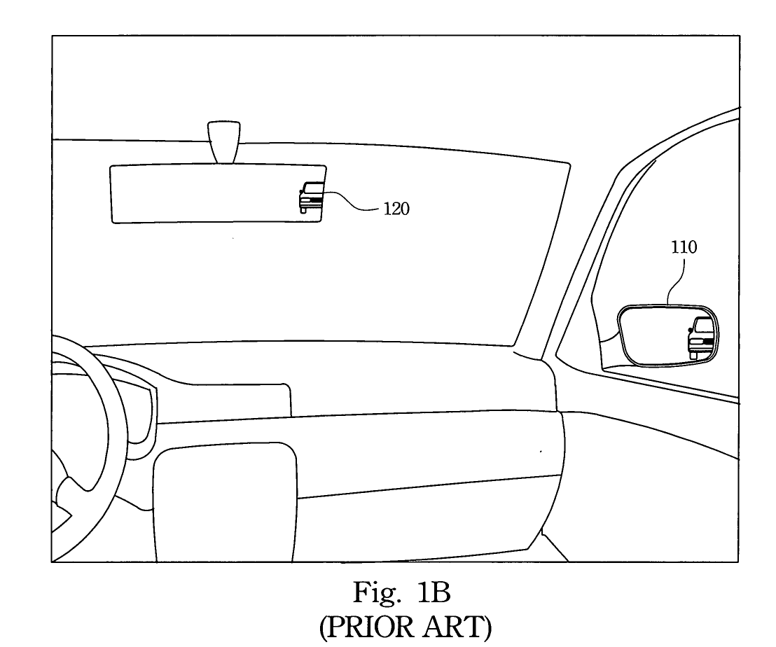

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

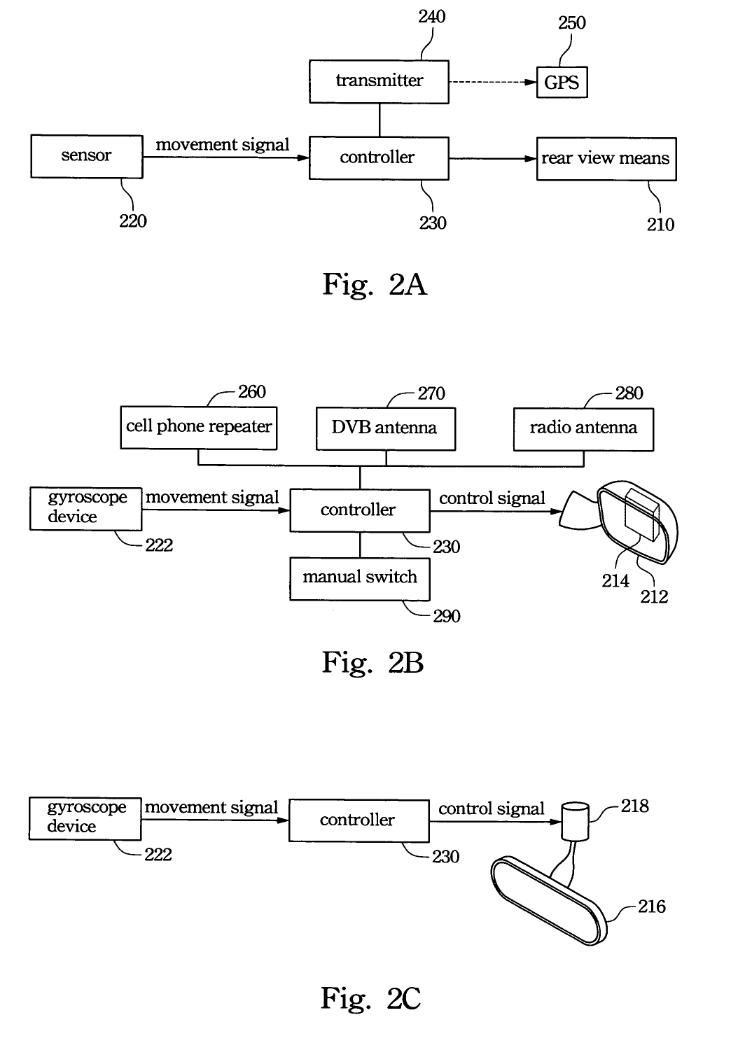

Reference is made to FIG. 2A which is a block diagram of a rear view system according to one preferred embodiment of this invention. In FIG. 2A, the rear view system for a transportation device includes a rear view means 210, a sensor 220 and a controller 230. The sensor 220 is used to generate a movement signal according to the movement of the transportation device. The controller 230 is used to control the rotation of the rear view means 210 according to the movement signal. The transportation device may be a vehicle, a motorcycle or a ship. Furthermore, the rear view means 210 may be a rear view mirror. The following embodiment will assume the transportation device is a vehicle for easy to illustrate.

The sensor 220 may be a differential. Because many commercial vehicles originally have a differential equipped therein, the rear view system may use this differential as the sensor 220. Thus, an additional sensor need not be added to the vehicle.

The sensor 220 may also be a gyroscope device. Because different vehicles have different differentials, the controller 230 may have to be adapted to identify the movement signal generated form different differentials. In order to avoid adapting the controller 230, the rear view system may employ the gyroscope device as the sensor 220. Thus, the rear view system will have the ability to be compatible with different vehicles without adapting the controller 230.

The rear view system may further include a transmitter 240. The transmitter 240 is electrically connected to the controller 230 for transmitting the movement signal to a global positioning system 250 (GPS). Using the movement signal and a map originally installed in the GPS 250, the GPS 250 will have the ability to show the position of the vehicle even if the vehicle is driven into a place without radio signals from satellites (such as a basement or a tunnel).

Reference is made to FIG. 2B which is a block diagram of a rear view system according to another preferred embodiment of this invention. In FIG. 2B, the sensor 220 (shown in FIG. 2A) is a gyroscope device 222. The rear view means 210 (shown in FIG. 2A) is an exterior mirror 212, and the exterior mirror 212 has a driving means 214 (such as a motor) configured therein for rotating the exterior mirror 212. The rear view assembly further includes a manual switch 290 for controlling the driving means 214 manually. Many commercial vehicles originally have a pair of exterior mirrors and a manual switch equipped therein, so the rear view assembly may employ the exteriors and the manual switch originally equip in the vehicles. Additional exteriors and manual switches may not be added to the vehicles. The controller 230 is electrically connected to the driving means 214 and the manual switch 290 to control the driving means 214. That is, the controller 230 generates a control signal response to the movement signal. Then, the driving means 214 rotates the exterior mirror 212 according to the control signal.

The rear view system may further include a cell phone repeater 260, a digital video broadcasting (DVB) antenna 270 and/or a radio antenna 280 electrically connected to the controller 230. Thus, cell phones, digital televisions (DTV) and/or radios will have excellent signal reception in the vehicle, which has the rear view system equipped therein according to this embodiment, because the controller 230 is electrically connected to the driving means 214 configured in the exterior mirror 212 (that is, the circuit of the controller 230 is extended to the outside).

Reference is made to FIG. 2C which is a block diagram of a rear view system according to still another preferred embodiment of this invention. In FIG. 2C, the sensor 210 (shown in FIG. 2A) is a gyroscope device 222. The rear view means 210 (shown in FIG. 2A) is an interior mirror 216, and the rear view system further includes a driving means 218 (such as a motor )coupled with the interior mirror 216 for rotating the interior mirror 216. The controller 230 is electrically connected to the driving means 218 to control the driving means 218. That is, the controller 230 generates a control signal response to the movement signal. Then, the driving means 218 rotates the interior mirror 216 according to the control signal.

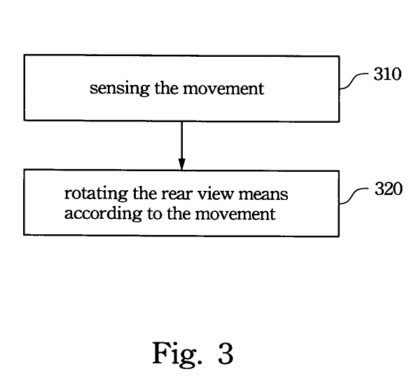

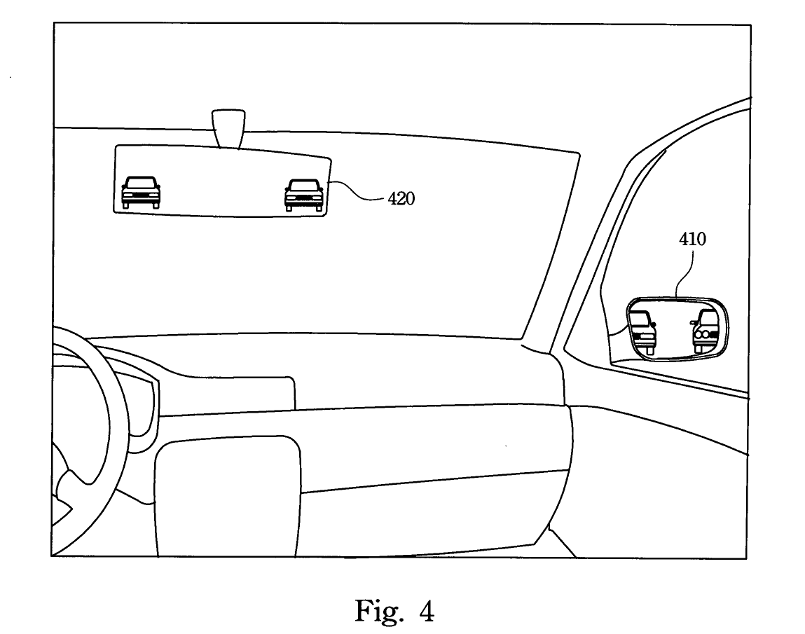

Reference is made to FIG. 3 which is a flow chart illustrating a method for adjusting the visual angle of a rear view means equipped in a transportation device according to one preferred embodiment of the present invention. In FIG. 3, a method for adjusting the visual angle of a rear view means equipped in a transportation device is provided. First, the movement of the transportation device is sensed (step 310). Then, the rear view means is rotated according to the movement of the transportation device (step 320). The sensing step 310 may be performed by a differential or a gyroscope device. Similarly, the following embodiment will assume the transportation device is a vehicle for easy to illustrate.

Reference is made to FIG. 4, which is a diagram showing the field of rear vision in the rear view means according to this embodiment when the vehicle turns right. When the vehicle makes a right turn, the rear view means (including an exterior mirror 410 and interior mirror 420) is rotated counterclockwise (looking from the top of the vehicle) to give the driver of the vehicle a better field of right-side rear vision. Similarly, when the vehicle makes a left turn, the rear view means is rotated clockwise (looking from the top of the vehicle) to give the driver of the vehicle a better field of left-side rear vision. In addition, the rear view means may be rotated upwardly when the transportation device is climbing up, and the rear view means may be rotated downwardly when the transportation device is climbing down as well.

Although the present invention has been described in considerable detail with reference to certain preferred embodiments thereof, other embodiments are possible. For example, the rear view means may be a left side exterior mirror, right side exterior mirror, interior mirror or combination thereof. When the vehicle makes a right turn, the right side exterior mirror may be rotated only or the right side exterior mirror and the interior mirror may be rotated together, and vice versa. Therefore, the spirit and scope of the appended claims should no be limited to the description of the preferred embodiments contained herein.

The rear view system according to the present invention can automatically adjust the visual angle of the rear view means according to the movement of the transportation device. Therefore, the driver can not only obtain a better field of rear vision, but drive more safely.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rear view system for a transportation device, comprising:
at least one rear view means;
a sensor for generating a movement signal according to the movement of the transportation device, wherein the sensor is a differential or a gyroscope device; and
a controller for controlling the rotation of the rear view means according to the movement signal.

2. The rear view system of claim 1, further comprising a transmitter electrically connected to the controller for transmitting the movement signal to a global positioning system.

3. The rear view system of claim 1, wherein the rear view means is an exterior mirror.

4. The rear view system of claim 3, wherein the exterior mirror has a driving means configured in the exterior mirror for rotating the exterior mirror.

5. The rear view system of claim 4, further comprising a manual switch for controlling the driving means manually.

6. The rear view system of claim 5, wherein the controller is electrically connected to the driving means and the manual switch for controlling the driving means.

7. The rear view system of claim 6, further comprising a cell phone repeater electrically connected to the controller.

8. The rear view system of claim 6, further comprising a digital video broadcasting antenna electrically connected to the controller.

9. The rear view system of claim 6, further comprising a radio antenna electrically connected to the controller.

10. The rear view system of claim 1, wherein the rear view means is an interior mirror.

11. The rear view system of claim 10, further comprising a driving means coupled with the interior mirror for rotating the interior mirror.

12. The rear view system of claim 11, wherein the controller is electrically connected to the driving means for controlling the driving means.

13. A method for adjusting the visual angle of a rear view means equipped in a transportation device, comprising the steps of:
sensing the movement of the transportation device; and
rotating the rear view means according to the movement of the transportation device.

14. The method of claim 13, wherein the sensing step is performed by a differential.

15. The method of claim 13, wherein the sensing step is performed by a gyroscope device.

16. The method of claim 13, wherein the rotating step comprises:
rotating the rear view means counterclockwise looking from the top of the transportation device when the transportation device makes a right turn.

17. The method of claim 13, wherein the rotating step comprises:
rotating the rear view means clockwise looking from the top of the transportation device when the transportation device makes a left turn.

18. The method of claim 13, wherein the rotating step comprises:
rotating the rear view means upwardly when the transportation device is climbing up.

19. The method of claim 13, wherein the rotating step comprises:
rotating the rear view means downwardly when the transportation device is climbing down.
